(19) United States
(12) Patent Application Publication
(10) Pub. No.: US 2002/0017855 A1
(43) Pub. Date: Feb. 14, 2002

(54) Visual display

(75) Inventors: Anthony J. Cooper, Murrieta, CA (US); Ingemar V. Rodriguez, San Diego, CA (US); William P. Bischoff, San Marcos, CA (US); Abdullah Abel, Oceanside, CA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Complete Substrate Solutions Limited

(21) Appl. No.: 09/873,976

(22) Filed: Jun. 1, 2001

Related U.S. Application Data
(60) Provisional application No. 60/208,776, filed on Jun. 1, 2000.

(30) Foreign Application Priority Data
Apr. 8, 1999 (US) PCT/US98/20813

(51) Int. Cl. H01J 1/62

(52) U.S. Cl. 313/495

(57) ABSTRACT

The front layer 1 shown in FIG. 1 is being tape cast in the direction of the arrow A from alumina ceramic material 2 onto a mylar layer 3. The doctor blade 4, which regulates the thickness T of the ceramic layer has serrations 5, which form parallel grooves 6 in the front surface 7 of the layer. After the material has set, by evaporation of the moisture allows the material to be sufficiently fluid for its casting, vias apertures 8 are punched in it, whilst it is still supported on the mylar, FIG. 2. They are filled with via material 9, FIG. 3, as described in more detail below. After via filling, the mylar layer is peeled from the tape cast ceramic.

For use the front layer 1 is laminated onto further ceramic layer(s) and fired. The grooves 6 are filled as by sputtering.

### FIELD OF THE INVENTION

The present invention relates to a visual display, particularly though not exclusively for use with data processing apparatus.

### BACKGROUND OF THE INVENTION

In prior International patent application, No. PCT/US98/20813, published on Apr. 8^{th} 1999 under No. WO 99/17330 (“The Earlier International Application”), we described and claimed:

a field effect emission device for a visual display comprising

substrate and

an emission layer on one face of the substrate, the emission layer having:

a multiplicity of emitters and gates, arranged as an array of emission pixels and

conductive connections in the emissions layer to the emitters and the gates;

the substrate having

conductive vias provided through the substrate or at least a front layer thereof to at least some of the said conductive connections in the emission layer for electrical connection to their emitters and gates.

In this specification we refer to the type of field emission device described in The Earlier International Application as the Front-Layer-Via FED Device.

We have now developed further and improved both the device and the display incorporating the device.

### Emitter Line Groove Aspect of the Invention

According to a first aspect of the present invention there is provided a field emission device for a visual display comprising:

a substrate having at least a front substrate layer and

an emission layer on a front face of the substrate, the emission layer having

a multiplicity of emitters and gates, arranged as an array of emission pixels and

conductive connections in the emission layer to the emitters and the gates, the conductive connections including:

emitter lines at the front face of the substrate;

the substrate having:

conductive vias provided through the substrate or at least a front layer thereof to at least some of the said conductive connections in the emission layer for electrical connection to their emitters and gates;

characterised in that the effect emission device further comprises:

grooves provided in the front surface of the substrate, the emitter lines being formed in the grooves.

According to a second aspect of the invention there is provided a method of providing emitter lines in a field emission device for a visual display, the field emission device having:

a substrate having at least a front substrate layer and

an emission layer on the front face of the substrate, the emission layer having;

a multiplicity of emitters and gates, arranged as an array of emission pixels and

conductive connections in the emission layer to the emitters and the gates, the conductive connections including:

emitter lines at the front face of the substrate,

the substrate having:

conductive vias provided through the substrate or at least a front layer thereof to at least some of the said conductive connections in the emission layer for electrical connection to their emitters and gates;

the method being characterised by the steps of:

forming grooves in the front surface of the substrate, and

filling the grooves to provide the emitter lines.

The grooves can be formed by serration of the doctor blade, which regulates the thickness of the front layer during its tape-casting from ceramic material. Alternatively it is preferred to form the grooves by chemical etching, since they are shallow, typically of the order of 1/10 of 1% of the thickness of the front layer, which itself is preferably between 0.005″ and 0.010″ thick. Where the front layer is a thick layer between 0.020″ and 0.40″, the grooves can be of the order of 4/100 of 1% of the thickness thereof. Again the grooves can be formed by laser cutting.

Preferably the emitter lines are of metal deposited as such, for example by sputtering of vacuum deposition. In the preferred embodiment, the metal is molybdenum. To enhance adherence of the sputtered molybdenum lines in their grooves, a preliminary sputtered coating of another metal having a good adherence to ceramic, such as tungsten, may he laid down.

Alternatively the lines can be formed by a process of slurry deposition and firing, typically by the resinate process, the layer being of the order of 10 thousandths of an inch thick.

To provide insulation from one emitter line to the next, and to provide a suitable surface for the production of emitter tips on, the deposited metal is polished back to the substrate material of the front layer after deposition.

Formation of the vias in the Front-Layer-Via FED Device can be relatively conventional. That is the vias in the front layer can be filled by screen printing, particularly with the application of vacuum in a register plate having vacuum passages aligned with vias. Alternatively, as is preferred, the vias can be filled by means of the pressure via fill system, in which via paste is forced through a mask having apertures aligned with the vias to be filled. In either case. the front layer is subsequently fired. Where the emitter lines have been deposited as a slurry, it is fired with the vias. Where the lines are to be sputtered, the vias are fired first.

In the former case, the via and line metals are preferably both of molybdenum the firing being at high temperature of the order of 1400° C. in a hydrogen atmosphere. In the latter case the preferred via material can be used as now described and the sputtered lines are still of molybdenum.

The grooves of the invention may find application in electronic components other than field emission devices.

Thus according to a third aspect of the invention, there is provided an electronic component to have an electrical component incorporated thereon, the electronic component comprising:

a substrate having

a at least a front substrate layer with a front face for receiving the electrical component and

conductive vias provided through the substrate or at least a front layer thereof to electrical connection to the electrical component;

characterised in that the electronic component further comprises:

grooves provided in the front surface of the substrate, the conductive lines being formed in the grooves for electrical connection to the electrical component.

According to fourth aspect of the inventions there is provided an electronic component comprising:

a substrate having

at least two substrate layers,

conductive tracks at interfaces and

conductive vias provided through the substrate layers and connecting with respective ones of the conductive interface tracks to provide electrical connection from one side of the substrate to the other;

characterised in that the electronic component further comprises:

grooves for the conductive tracks provided in a surface at one or more of the substrate layers, the conductive tracks being formed in the grooves.

### Expansive/Resistive Via aspect of the Invention

In accordance with a particularly preferred feature of the invention, which may find application independently of the formation of grooves in front surface of the substrate, the vias may be formed of or based on a material which expands by reaction on firing of the substrate.

Preferably the material is or comprises a metal which expands by reaction on firing of the substrate.

The preferred via material is a ruthenium containing paste It is fired in an oxidising atmosphere, conveniently air, at a temperature of the order of 850° C. The ruthenium oxidises, and in doing so expands to a small degree. This assists in eliminating voids in the vias between the via material and the front layer material. The expansion tents to create so called posting of the vias, namely their expansion out of the piano of the layer. This assists in ensuring electrical contact with inter-layer interconnections.

Conveniently the expanding via paste is bulked with other material which is inert to the reaction causing expansion. In the case of the ruthenium, precious metal which does not oxidise, e.g. gold or silver, or ceramic material can be used for bulking.

Ruthenium oxide has the further advantage of being resistive. Bulking with precious metal provides lower resistance vias; whilst bulking with ceramic material provides relatively higher resistance vias.

The expansive vias of the invention may find application in electronic components other than field emission devices.

According to a fifth aspect of the invention there is provided an electronic component comprising:

a substrate having

at least two substrate layers,

conductive tracks at interfaces and

conductive vias provided through the substrate layers and connecting with respective ones of the conductive interface tracks to provide electrical connection from one side of the substrate to the other,

characterised in that the electronic component further comprises,

grooves for the conductive tracks provided in a surface of one or more of the substrate layers, the conductive tracks being formed in the grooves.

According to a sixth aspect of the invention there is provided an electronic component comprising:

a substrate having

at least a front substrate layer with a front face for receiving the electrical component and

via aperture through the substrate or at least a front layer thereof and filled with via material to provide electrical connection to the electrical component;

characterised in that.

the via material is formed of or includes a material which expands by reaction on firing of the substrate.

### Substrate Lamination Alternatives

The substrate may be a multilayer substrate having a front substrate layer and at least one additional substrate layer, with conductive vias provided through the front layer and the or each additional layer and with electrical interconnection tracks at least some of the interface(s) between adjacent layers so arranged that a front layer via is offset from a via in back one of the additional layer(s) to which it is electrically connected by the interconnection tracks the back one of the additional layers being provided with a connection arrangement. Nevertheless, it is conceivable that the substrate should be a comprised of or include two layers with vias in one aligned with vias in the next, particularly where one layer is much thicker than the other as described below It is also envisaged that the substrate may have only a single layer

It is specifically within the contemplation of the present invention that the substrate can be a single layer of ceramic having the grooves in the front surface and vias straight through to a connection arrangement at the back face of the substrate. A back plate is provided with a multilayer to provide fan-out to driver chip(s).

Alternatively the substrate having the emission layer and connected in use to a back plate may be provided with a plurality of layers.

In both the substrate having the emission layer and the back plate, the multiple layers can be provided by lamination of ceramic layers as described in The Earlier Patent Application.

However,it should also be noted that the substrate may be provided as a multilayer having driver chips connected directly to its back surface.

### Foundation Layer Aspect Of The Invention

In accordance with a preferred feature of the invention, the front layer alone, or in combination with a lay-up of a plurality of layers, is preferably laminated when still in the untired/green state to a thicker foundation layer of fired ceramic.

Thus preferably, the substrate comprises:

a least one and preferably a plurality of thin, ceramic layers and

a thicker, foundation, ceramic layer.

This has the substantial advantage of the laminated layer(s) retaining the X & Y dimensions of the foundation layer on firing even although it or they shrink in the Z direction. The foundation layer can be expected to have shrunk in the X & Y dimensions on firing, but a via pattern in it can be drilled by laser following this first firing. Further, the surface of the foundation layer due to receive the front layer or lay-up including it—can be polished prior to the lamination. Further the vias can be filled and their posting ground off prior to lamination This results in a well defined flat surface of the front layer.

Further green layers can be laminated to the backside of the foundation layer.

The foundation layer can be between 3 and 10 times thicker than an individual green laminate. With the latter being between 0.005″ and 0.010″ thick. the foundation layer can be between 0.015″ and 0.100″ thick Typically the foundation layer will be between 0.020″ and 0.030″ thick.

Where a substrate having an emission layer and a back plate having the front substrate connected to it are separately provided, both preferably have a thick layer. whilst one or other has one or more thin layers in its multilayer. Again it is specifically contemplated that one of the substrates may be provided simply of a single thick foundation layer.

Use of thick layers as a foundation for multilayers has advantage not only in providing X & Y dimensional stability, but also in providing sufficient stiffness for the substrate to resist breakage in processing and use as might happen with a multilayer of only a few layers, each substantially thinner than the thick layer.

All the laminated layers typically have their vias filled with ruthenium paste prior to lamination Interconnection tracks between vias of different layers can be provided by screen printing of gold or silver slurry onto the surface of the tape cast green material. Vias can be punched in it whilst still green and supported on a mylar or the like membrane on which it is cast.

Whilst the back layer of the multilayer substrate may be provided with electrical connection tracks to contact, preferably the back layer is plain except for vias For connection to driver components, e.g. driver chips the free ends of the vias air provided with solder paste which is flowed into balls for solder connection of components. Alternatively, the vias can have precious metal balls for solder connection of flip chip/chip scale connections. Such solder or precious metal balls are said to be arranged in a ball grid array.

The preferred thick and thin layers combination in the substrate may find application in electronic components other than field emission devices.

Thus according to a seventh aspect of the invention there is provided an electronic component to have an electrical component incorporated thereon, the electronic component comprising:

a substrate having:

a front substrate layer with a front face for receiving the electrical component,

at least one further substrate layer and

via and interconnect arrangement for providing electrical connection to the electrical component, the electrical connection being distributed across the front face.

characterised in that the substrate layers comprise;

at least one thin, ceramic layer and

a thicker, foundation, ceramic layer, the thin layer(s) having been laminated in green state to the thick layer which has previously been fired, the substrate being fired after lamination.

Further according to the eighth aspect of the invention there is provided an electronic component comprising a multilayer substrate having a plurality of vias and interconnects for providing electrical connection between one set of electrical features on one face and another set of electrical features on the other face thereof the two sets of electrical features being differently arranged on the two faces, the substrate having

a lateral extension formed integrally with the substrate and carrying a third set of electrical features, the third set being contacts connected one-to-one to the second set, whereby the component can be tested via the third set of contacts and

a fracture line in the substrate at a juncture of the lateral extension to the substrate for removing the extension and the third set of contacts by fracture alone the line after testing.

According to a ninth aspect of the invention there is provided a via fill material for filling via apertures in a substrate of an electronic component, the material formed of or including a material which expands by reaction on firing of the substrate.

### THE DRAWINGS

To help understanding of the invention, specific embodiments thereof now be described, with reference to the accompanying drawings, in which:

FIG. 1 is a scrap side view of a front layer for a device of the invention being tape cast in green form;

FIG 2 is a scrap plan view of the front layer with punched via holes,

FIG. 3 is a cross-sectional on the line III-III in FIG. 2 of the front layer with the via holes filled with via materia,

FIG. 4 is a view similar to FIG. 3 of a foundation layer, fired, with filled vias and polished on both sides;

FIG. 5 is a view similar to FIG. 4 with the front layer laminated onto the front side of the foundation layer and further layers laminated onto its back side,

FIG. 6 is a cross-sectional view similar to FIG. 5, but transverse to the direction of the line III-III in FIG. 2, showing sputtered emitter lines;

FIG. 7 is a view similar to FIG. 6 showing chemically etched emitter line grooves;

FIG. 8 is another similar view showing laser cut emitter line grooves;

FIG. 9 is a diagrammatic view of a pressure via fill system for filing the vias in the front layer;

FIG. 10 is a similar view of a screen print via fill system;

FIG. 11 is a scrap cross sectional view showing a driver chip connected to a multilayer of the invention with a ball grid array,

FIG. 12 is a view of a reflow solder connection.

### PREFERRED EMBODIMENTS OF THE INVENTION

### Tape Cast Serrations

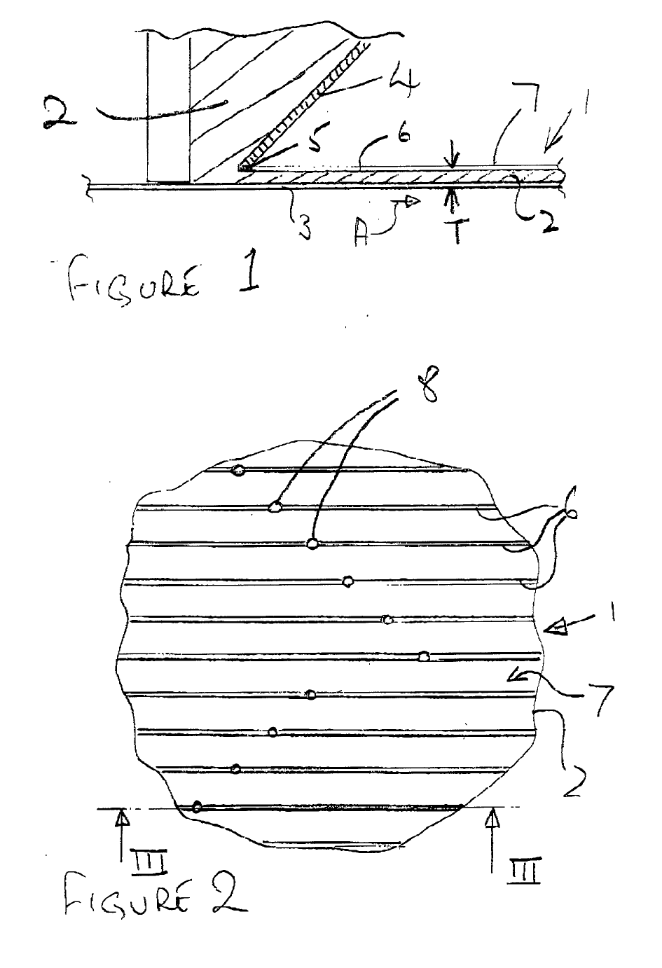

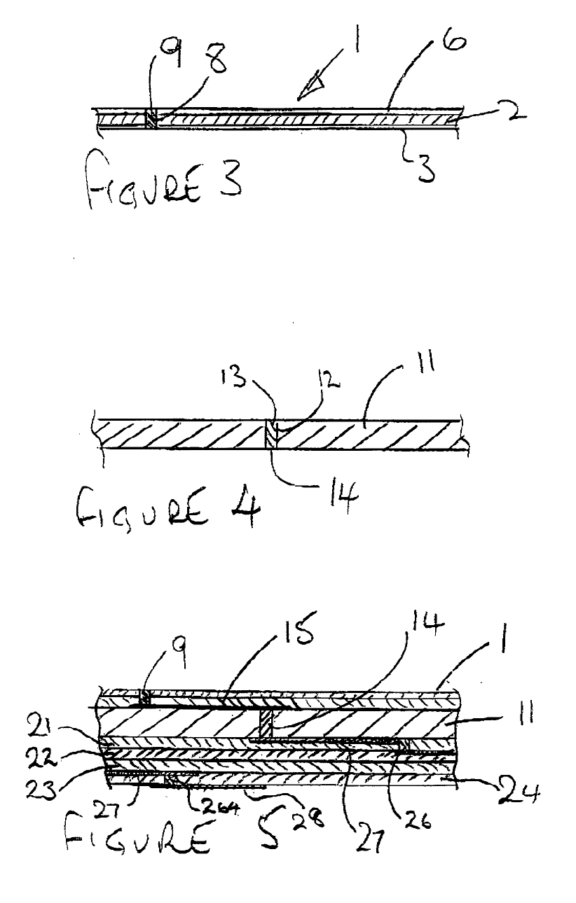

Turning first to FIG. 1, the front layer 1 there shown is being tape cast in the direction of the arrow A from alumina ceramic material 2 onto a mylar layer 3. The doctor blade 4, which regulates the thickness T of the ceramic layer has serrations 5, which form parallel grooves 6 in the front surface 7 of the layer. After the material has set, by evaporation of the moisture allowing the material to be sufficiently fluid for its casting, vias apertures 8 are punched in it, whilst it is still supported on the mylar, FIG. 2. They are filled with via material 9. FIG. 3, as described in more detail below. After via filling, the mylar layer is peeled from the tape cast ceramic

The next layer in the multilayer will be a foundation layer 11 which is substantially thicker than the front layer 1. FIG. 4 It should be noted that the thickness of the front layer has been exaggerated in the drawings. Typically the fired thickness of the front layer 1 will be 0.006″, whilst the tired thickness of the foundation layer will be 0.030″ The latter has an array of via apertures 12 punched in it in the green state. Alternatively, in order to more precisely define their position, because on firing the ceramic can be shrunk by between 10% and 20%, the via apertures can be drilled by laser after firing. In order to ensure that the foundation layer is perfectly flat, particularly to ensure that the emission layer when formed will be flat. the foundation layer is polished after firing. Its vias are then filled with via material 13, either by mean, of pressure feeding of the material through a mask into the vias on by screen printing whilst applying a vacuum to the opposite ends of the vias. Since the preferred via material (see below) swells slightly on firing, the foundation layer is repolished front and back to ensure that the finished vias 14 are flush at their ends with the surfaces of the foundation layer. Alternatively, the polished prior to via filling can be omitted, with the front and back surfaces beings polished together with the vias in a single operation.

For connection to the vias in the front layer, when the front layer is laminated to the foundation layer, interconnection tracks 15 can be screen printed onto the polished front surface of the foundation layer. Alternatively, the array or pattern of the vias may be identical between the front layer and the foundation layer, whereby pressure lamination of the front layer onto the foundation layer ensures that the respective vias interconnect directly Small interconnection pads could be screen printed onto the foundation layer at the vias, to allow for slight misalignment of the vias in the two layers.

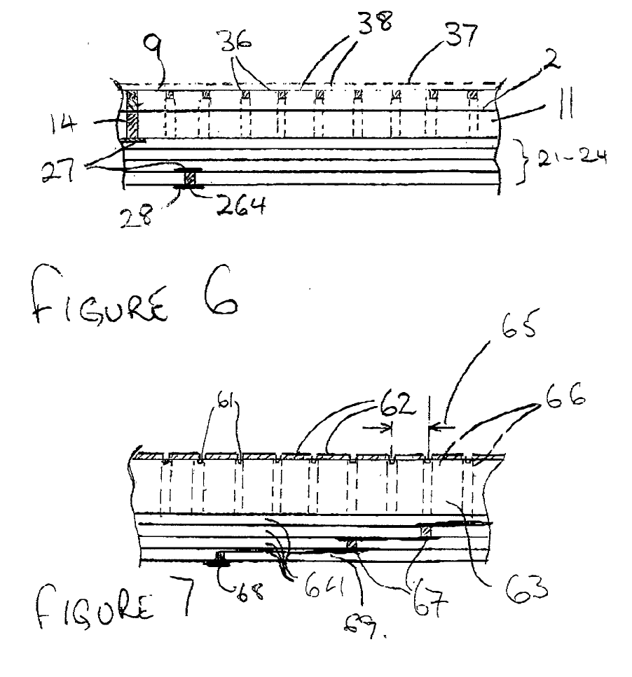

Further layers of the same order of thickness as the front layer, for 21,22,23,24 in number as shown in FIGS. 5 & 6, with vias 26 and interconnections 27 at layer interfaces, are laminated in the green state onto the back of the foundation layer. The vias can be provided as above. The interconnections can be provided as screen printing of silver or gold lines, screen printed onto the layers whilst they are still supported on their mylar tape-casting backings. The entire lamination is then fired togehter into a unified structure. Lamination of the green layers onto the foundation layer has the advantage of restricting the X & Y dimensional shrinkage of the layers on firing, since they retain the dimensions of the pre-fired foundation layer to which they are laminated The lamination does however shrink in the Z dimension. in which it is not restrained. This arrangement ensures that the connections established between the vias and the interconnections in the green state do not become disturbed. Also, the pitch of the vias 8 and the grooves 6 does not shrink. In particular the grooves will be in their designated position for build up of the emission layer over them. Further, the vias 264 in the back layer 24 will be in their design position for connection to them, either direct as described in more detail below or by means of electrical connection strips 28 screen printed onto the laminated multilayer prior to firing of the multilayer.

### Sputtered Filling Of Grooves

After this firing the grooves 6 are filled by sputtering of molybdenum 36 into them. The sputtering 37 will cover the entire front surface of the front layer including the lands 38 between grooves To isolate the individual lines of molybdenum in the grooves, the front surface of the fired front layer is polished. This removes the molybdenum on the lands, leaving the metal in the grooves polished, which is advantageous for deposition of emitter tips at the next stage in the manufacturing process at least as regards the front surface.

### Alternative Front Layer Grooves

As an alternative to the formation of the grooves by serrations on the doctor blade, the front layer can be formed with a completely plain front surface, except for the vias through it, see FIG. 7. Grooves 61 analogous to the grooves 6 can then be chemically etched in it—and indeed in the vias protruding into the path of the grooves. Etching is advantageous, hearing in mind that depth of the grooves can be 1/10 of 1% of the thickness of the front layer, i.e, of the order of 0.000006″, i e 6 millionths of an inch. In this respect, it should be noted that the depth of the grooves shown in the drawings is greatly exaggerated. Such etching it shown in FIG. 7 through a mask 62, which is deposited for etching of the substrate and then itself etched away. The grooves 61 themselves are so shallow as to be indiscernible to the eye and are exaggerated in FIG. 7. The front layer 63 of the substrate in which they are etched is a “thick” prefired ceramic substrate, typically 0.030″ thick. Four thin layers 64 are laminated to the back of the thick layer to fan out from the pitch 65 of the emitter lines to be laid down in the grooves and of their vias 66 to that of the back layer contacts pads 68. The fanned out electrical tracks being vias 67 and interconnects 69.

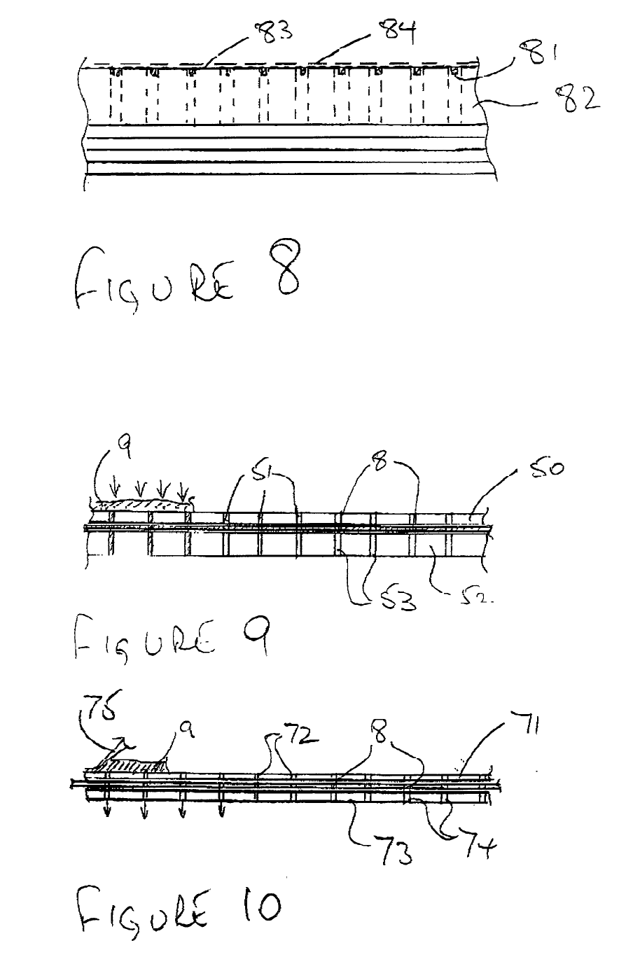

The alternative shown in FIG. 8 is very similar, except that the grooves 81 have been cut by laser in the thick front layer 82. As such they are deeper than the etched grooves. In order to improve adherence of the sputtered molybdenum in the grooves a first sputtering 83 of tungsten is made followed by a thicker sputtering 84 of molybdenum to fill the grooves. Both the tungsten and the molybdenum are polished off the lands between the grooves following filling of the grooves.

### Preferred Via Materials

The preferred via till materials are pastes which are a mixture of ruthenium metal and silica or a mixture of ruthenium and precious metal such as gold or silver. On firing in air, typically at 850° C., the ruthenium metal oxidises The oxide occupies a greater space than the metal. Thus the via fill material swells to pack the vias

The nature of the via paste is novel, in that it comprises at least a significant proportion of ruthenium powder. Ruthenium, whilst relatively unreactive, oxidises more readily than gold or silver. Its oxide occupies a greater volume than the original metal. Thus when the paste is fired, the via material expands, particularly longitudinally of the via apertures This is of advantage in ensuring good contact at the interfaces between the ceramic layers.

A further advantage of ruthenium paste is that on firing its expansion is not limited to being longitudinal. Lateral expansion tends to pack the material more tightly in the via aperture, with result that the hermeticity of the layer and the multilayer as a whole is improved. This is because potential leakage paths along the vias are closed This is of particular significance for the thick foundation layers.

Further, ruthenium oxide is an electrically resistive material. Thus the can be provided with a determined resistance. This is of advantage particularly in respect of the vias to the emitter lines.

In an FED pixel comprising a plurality of emitter tips, failure can occur due to one tip emitting too readily and drawing current from the rest of the tips, which then ulilit insufficiently. In extreme cases, arcing can occur between the tips and the phosphors. With the vias being of resistive material, the current that can be drawn by an individual pixel and hence by an individual tip is limited by the via. This results in less likelihood of tip burn out and arcing.

The vias, in the green ceramic layers, are filled by urging via paste into the via apertures 8, in a so called pressure via fill system As shown in FIG. 9, the paste can be forced under pressure through a mask 50 having apertures 51 corresponding in position to the via apertures 8, in the case of the front layer. A support 52, also having corresponding apertures 53, holds the green ceramic against the mask, whilst the via paste 9 is forced into the apertures under pressure applied over the mask. The vias in the thick, pre-fired ceramic layers can be filled in the same way

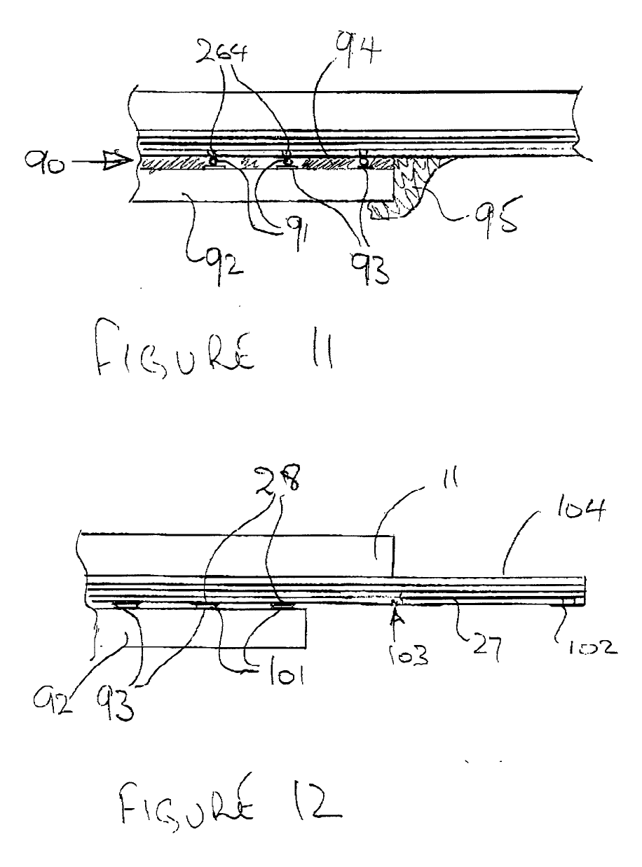

Alternatively as shown in FIG. 10. the ceramic is positioned between a screen printing screen 71 having via position apertures 72 and a vacuum plate 73 again having via position apertures 74. The via paste 9 is applied by the screen printing blade 75, whilst a vacuum is applied to the underside of the vacuum plate. Thus paste is squeezed and drawn into the vias.

Referring now to FIG. 11, the multilayer there shown has an a ball grid array 90 formed on its back surface. Each via 264 to the back surface has a ball 91, preferably of gold, welded to it. This enables connection of driver chips by so called “flip chip” or “chip scale packaging” technology. The driver chip 92 has surface contacts 93 arranged complementarily to the gold balls 91 The chip is abutted onto the hack surface of the multilayer in the correct position. Epoxy 94 is introduced to fill the gap between the chip and the back layer When this has set, a further application of epoxy 95 is made to cover the chip, which is thus securely held in position and electrically connected.

Alternatively, FIG. 12 the vias in the back layer are provided with screen printed extension pads 28 to provide them with greater surface area, are provided with screen printed solder paste 101. The tracks and the paste are suitable for surface mounting of driver chips 92 via their contacts 93, the solder being reflowed in a conventional manner.

To facilitate testing of the FED device, which would otherwise be possible only after the driver and other chips had been connected on as just described, the four back layers of the substrate can be provided with edges extending beyond the extent of the foundation layer 11. These have edge contacts 102, corresponding to the ball grid array with a one to one connection between the individual ones of the contacts 102 and the pads 28. The device can be tested by connection to the contacts 102. If it tests satisfactorily, the edges and their contacts can remain, suitable electrically insulated Alternatively, score lines 103 can be provided corresponding to the edges of the foundation layer 11. The ceramic material, being brittle, can be readily snapped at the score lines removing the overhanging edges 104. If required, the interconnection tracks 27 exposed at the breaks can be insulated with potting epoxy material.

### Alternative Groove Filling

As an alternative to sputtering of the molybdenum into the grooves in the front surface of the front layer, the metal can be screen printed in a so called resinate process. However, to form the metal into coherent lines in the grooves, it must be fired at 1400° C. in a hydrogen or at least reducing atmosphere. This is too high a temperature for the ruthenium via material. Thus the vias in the front layer and any other layers laminated thereto at this stage are conveniently of molybdenum These layers can be the front layer and the foundation layer. The additional layers of the multilayer for fanning the connection pitch can be subsequently laminated and fired on the back of the foundation layer. Ruthenium can be used in the vias

Thus whether the molybdenum is sputtered or applied by the resinate process, the resulting fired multilayers have polished, molybdenum emitter lines on the front and fanned out electrical connections on the back. Not all the vias to the front layer connect to the emitter lines. An equivalent number are provided for gate lines to be deposited on in a process forming no part of the present invention as such. Further, other vias are provided for other connections in the display.

1. A field emission device for a visual display comprising:
a substrate having at least a front substrate layer and
an emission layer on a front face of the substrate, the emission layer having:
a multiplicity of emitters and gates, arranged as an array of emission pixels and
conductive connections in the emission layer to the emitters and the gate; the conductive connections including;
emitter lines at the front face of the substrate
the substrate having:
conductive vias provided through the substrate or at least a front layer thereof to at least some of the said conductive connections in the emission layer for electrical connection to their emitters and gates;
characterised in that the field effect emission device further comprises:
a grooves provided in the front surface of the substrate the emitter lines being formed in the grooves

2. A field emission device according to claim 1, wherein the front substrate layer is of ceramic and the grooves are formed by serration of a tape-casting, doctor blade.

3. A field emission device according to claim 1, wherein the front substrate layer is of ceramic and the grooves are formed by laser cutting.

4. A field emission device according to claim 1, wherein the front substrate layer is of ceramic and the grooves are formed by chemical etching.

5. A field emission device according to claim 4, wherein the grooves are shallow, being of the order of 1/10 of 1% of the thickness of the front layer, the front layer being between 0.005″ and 0.010″ thick.

6. A field emission device according to claim 4 wherein the grooves are shallow, being of the order of 4/100 of 1% of the thickness of the from layer. the front layer being between 0.020″ and 0.040″ thick.

7. A field emission device according to claim 1, wherein the emitter lines are of metal deposited by sputtering.

8. A field emission device according to claim 1, wherein the emitter lines are of metal deposited by vacuum deposition.

9. A field emission device according to claim 1, wherein the emitter lines metal is molybdenum.

10. A field emission device according to claim 9, wherein the emitter lines are of metal deposited by sputtering and to enhance adherence of the sputtered molybdenum lines in the grooves, a preliminary sputtered coating of another metal having a good adhere to ceramic is laid down.

11. A field emission device according to claim 1 wherein the emitter lines are a fired slurry deposition.

12. A field emission device according to claim 1, wherein at least the vias in the front layer of the substrate are filled with a via material formed of or including a material which expands by reaction on firing of the substrate.

13. A field emission device according to claim 12, wherein the via fill material is or comprises a metal which expands by oxidation on firing of the substrate.

14. A field emission device according to claim 12, wherein via fill material is a ruthenium containing paste.

15. A field emission device according to claim 12, the expansible material is bulked with other material which is inert to the reaction causing expansion.

16. A field emission device according to claim 15, wherein bulking material is a precious metal or a ceramic material.

17. A field emission devise as claim in claim 1, wherein the substrate is a multilayer substrate having a front substrate layer and at least one additional substrate layer, with conductive vias provided through the front layer and the or each additional layer and with electrical interconnection tracks at least some of the interface(s) between adjacent layers so arranged that a front layer via is offset from a via in a back one of the additional layer(s) to which it is electrically connected by the interconnection tracks, the back one of the additional layers being provided with a connection arrangement.

18. A field emission device according to claim 17, in combination with a back plate with a plurality of layers to provide fan-out to driver chip(s), the substrate and the back plate being connected by the connection arrangement.

19. A field emission device according to claim 1, wherein the substrate is comprised of or includes two layers with vias in one aligned with vias in the next.

20. A field emission device according to claim 1, the substrate is a single layer of ceramic having the grooves in the front surface and vias straight through to a connection arrangement at a back face of thc substrate.

21. A field emission device according to claim 19, in combination with a back plate with a plurality of layers to provide fan-out to driver chip(s), the substrate and the back plate being connected by the connection arrangement.

22. A field emission device according to claim 1, wherein the substrate comprises:
a plurality of thin, ceramic layers and
a thicker, foundation, ceramic layer

23. A field emission device according to claim 22, wherein the foundation layer is between 3 and 10 times thicker than the thin layers.

24. A field emission devices according to claim 23, wherein the foundation layer is between 0.015″ and 0.100″ thick and the thin layers are between 0.005″ and 0.010″ thick.

25. A field emission device according to claim 24, wherein the foundation layer is between 0.020″ and 0.030″ thick.

26. A field emission device according to claim 22. in combination with a back plate having a thick foundation layer and a plurality of thin layers to provide fan-out to driver chip(s), the substrate and the back plate being connected by the connection arrangement.

27. A method of providing emitter lines in a field emission device for a visual display, the field emission device having:
a substrate having at least a front substrate layer and
an emission layer on a front face of the substrate, the emission layer having,
a multiplicity of emitters and gates, arranged as an array of emission pixels and
conductive connections in the emission layer to the emitters and the gates, the conductive connections including:
emitter lines at the front face of the substrate;
the substrate having,
conductive vias provided through the substrate or at least a front layer thereof to at least some of the said conductive connections in the emission layer for electrical connection to their emitters and gates:
the method being characterised by the steps of
forming grooves in the front surface of the substrate, and
filling the grooves to provide the emitter lines.

28. A method of providing emitter lines according to claim 27, wherein the front substrate layer is of ceramic and the method includes the step of
forming the grooves by tape casting the front layer of the substrate using a serrated a tape-casting, doctor blade, the grooves being formed by the serrated blade.

29. A method of providing emitter lines according to claim 27, wherein the front substrate layer is of ceramic
forming the grooves by laser cutting.

30. A method of providing emitter lines according to claim 27, wherein the front substrate layer is of ceramic and the method includes the step of
the grooves are formed by chemical etching.

31. A method of providing emitter lines according to claim 30, wherein the grooves are shallow, being of the order of 1/10 of 1% of the thickness of the front layer, the front layer being between 0.005″ and 0.010″ thick.

32. A method of providing emitter lines according to claim 30, wherein the grooves are shallow, being of the order of 4/10 of 1% of the thickness of the front layer. the front layer being between 0.020″ and 0.040″ thick.

33. A method of providing emitter lines according to claim 27, wherein the emitter lines are of metal deposited by sputtering.

34. A method of providing emitter lines according to claim 27, wherein the emitter lines are of metal deposited by vacuum deposition.

35. A method of providing emitter lines according to claim 33, where in the emitter lines are of metal molybdenum.

36. A method of providing emitter lines according to claim 35, wherein the emitter lines are of metal deposited by sputtering and including the step of a preliminary sputtering of a metal having a good adherence to ceramic, to enhance adherence of the molybdenum lines in the grooves.

37. A method of providing emitter lines according to claim 27, wherein the emitter lines are deposited as a slurry which is subsequently fired.

38. A method of providing emitter lines according to claim 37, wherein the slurry deposition is by a resinate process, the fired deposition being of the order of 10 thousandths of an inch thick.

39. A method of providing emitter lines according to claim 38 wherein the fired deposition is polished back to the substrate material of the front layer after firing, to provide a suitable surface for the production of emitter tips thereon.

40. A method of providing emitter lines according to claim 27, in combination with the steps of filling of vias in the front layer of the substrate by screen printing of via material and of subsequently firing the front layer, after slurry deposition of the emitter lines if appropriate.

41. A combined method according to claim 40, including application of vacuum in a register plate having vacuum passages aligned with the vias for drawing the via material through the vias.

42. A method of providing emitter lines according to claim 27, in combination is with the steps of filling of vias in the front layer of the substrate by forcing via material under pressure through a mask having apertures aligned with the vias to be filled and of subsequently firing the front layer, after slurry deposition of the emitter lines if appropriate.

43. A combined method according to claim 27, in combination with the steps of filling of vias in the front layer of the substrate and wherein the emitter lines are deposited as a slurry, and the via material and the slurry deposited material are fired together.

44. A combined method according to claim 43, wherein the via and line metallic materials are both of molybdenum, the firing being at high temperature of the order of 1400° C. in a hydrogen atmosphere.

45. A combined method according to claim 27, in combination with the steps of filling of vias in the front layer of the substrate and wherein the via fill materials expands by reaction on firing.

46. A combined method according to claim 45, wherein the firing is performed in an oxidising atmosphere, the via fill material being comprised of or including an oxidisable metal.

47. A combined method according to claim 27, in combination with the steps of filling of vias in the front layer of the substrate and including the step of laminating the front ceramic layer alone, or a lay up of a plurality of ceramic layers including the front ceramic layer, and/or one or more rear layers in the unfired/green state to a thicker foundation layer un fired ceramic.

48. A combined method according to claim 47, including the step of laser drilling and filling of via apertures in the foundation layer after its first firing and prior to lamination thereto.

49. A combined method according to claim 47, including the step of polishing the front face of the foundation layer prior to lamination of green layers thereto.

50. A combined method according to claim 47, wherein the thin layers are tape cast onto a plastics material backing.

51. A combined method according to claim 50. wherein the via apertures are punched and filled with via material whilst the layer is supported on the plastics material backing.

52. A combined method according to claim 51, wherein the interconnection tracks arc screen printed onto the layers whilst still green.

53. An electronic component to have an electrical component incorporated thereon, the electronic component comprising:
a substrate having
at least a front substrate layer with a front face for receiving the thereon, the electronic component comprising:
conductive vias provided through thc substrate or at least a front layer thereof to electrical connection to the electrical component;
characterized in that the electronic component further comprises
grooves provided in the front surface of the substrate the conductive lines being formed in the grooves for electrical connection to the electrical component.

54. An electronic component according to claim 53, wherein the front substrate layer is of ceramic and the grooves are formed by serration of a tape-casting, doctor blade.

55. An electronic component according to claim 53, wherein the front substrate layer is of ceramic and the grooves are formed by laser cutting.

56. An electronic component according to claim 53, wherein thc front substrate layer is of ceramic and the grooves are formed by chemical etching.

57. An electronic component according to claim 52, wherein the conductive lines are of metal deposited by sputtering.

58. An electronic component according to claim 52, wherein the conductive lines are of metal deposited by vacuum deposition.

59. An electronic component according to claim 52. wherein the conductive lines are a fired slurry deposition.

60. An electronic component comprising:
a substrate having
at least two substrate layers,
conductive tracks at interfaces and
conductive vias provided through the substrate layers and connecting with respective ones of the conductive interface tracks to provide electrical connection from one side of the substrate to the other,
characterised in that the electronic component further comprises
grooves for the conductive track provided in a surface of one or more of the substrate layers, the conductive tracks being formed in the grooves.

61. An electronic component according to claim 60. wherein the substrate layers are of ceramic and the grooves are formed by serration of a tape-casting doctor blade.

62. An electronic component according to claim 60, wherein the substrate layers are of ceramic and the grooves are formed by laser cutting.

63. An eletronic component according to claim 60, wherein the substrate layers are of ceramic and the grooves are formed by chemical etching.

64. An electronic component according to claim 60, wherein the conductive tracks are of metal deposited by sputtering.

65. An electronic component according to claim 60, wherein the conductive tracks are of metal deposited by vacuum deposition.

66. An electronic component according to claim 60, wherein the conductive tracks are a fired slurry deposition.

67. An electronic component to have an electrical component incorporated thereon, the electronic component comprising:
a substrate having
at least a front substrate layer with a front face for receiving the electrical component and
via apertures through the substrate or at least a front layer thereof and filled with via material to provide electrical connection to the electrical component;
characterised in that,
the via material is formed of or includes a material which expands by reaction on firing of the substrate.

68. An electronic component according to claim 67, wherein the via fill material is a metal which expands by oxidation on firing of the substrate.

69. An electronic component according to claim 67, wherein via fill material is a ruthenium containing paste.

70. An electronic component according to claim 67, the expansible material is bulked with other material which is inert to the reaction causing expansion.

71. An electronic component according to claim 70, wherein bulking material is a precious metal or a ceramic material.

72. An electronic component comprising:
a substrate having
at least two substrate layers,
conductive tracks at interfaces and
via apertures through the substrate layers and filled with via material to provide electrical connection with respective ones of the conductive interface tracks to provide electrical connection from one side of the substrate to the other,
characterised in that:
the via material is formed of or includes a material which expands by reaction on firing of the substrate.

73. An electronic component according to claim 72, wherein the via fill material is a metal which expands by oxidation on firing of the substrate.

74. An electronic component according to claim 72, wherein via fill material is a ruthenium containing paste.

75. An electronic component according to claim 72, the expansible material is bulked with other material which is inert in the reaction causing expansion.

76. An electronic component according is claim 75, wherein bulking material is a precious metal or ceramic material.

77. An electronic component to have an electrical component incorporated thereon, the electronic component comprising:
a substrate having
a front substrate layer with a front face for receiving the electrical component,
at least one further substrate layer and
via and interconnect arrangement for providing electrical connection to the electrical component the electrical connection being distributed across the front face.
characterised in that the substrate layers comprise:
at least one thin, ceramic layer and
a thicker, foundation, ceramic layer, the thin layer(s) having been laminated in green state to the thick layer which has previously been fired, the substrate being fired after lamination.

78. An electronic component according to claim 77, wherein the foundation layer is between 3 and 10 times thicker than the thin layers.

79. An electronic component according to claim 78, wherein the foundation layer is between 0.015″ and 0.100″ thick and the thin layers are between 0.005″ and 0.0010″ thick.

80. An electronic component according to claim 79, wherein the foundation layer is between 0.020″ and 0.030″ thick.

81. All electronic component comprising, a multilayer substrate having a plurality of vias and interconnects for providing electrical connection between one set of electrical features on one face and another set of electrical features on the other face thereof, the two sets of electrical features being differently arranged on the two faces, the substrate having
a lateral extension formed integrally with the substrate and carrying a third set of electrical features, the third set being contacts connected one to one to the second set, whereby the component can be tested via the third set of contacts and
a fracture line in the substrate at a juncture of the lateral extension to the substrate for removing the extension and the third set of contacts by fracture along the lines after testing.

82. A via fill material for filling via apertures in a substrate of an electronic component, the material formed of or including a material which expands by reaction on firing of the substrate.

83. A field emission device as claimed in claim 82, wherein the via fill material is a metal which expands by oxidation on firing of the substrate.

84. A field emission device as claimed in claim 82, wherein via fill material is a ruthenium containing paste.

85. A field emission device as claimed in claim 82, the expansible material is bulked with other material which is inert to the reaction causing expansion.

86. A field emission device as claimed in claim 85, wherein bulking material is a precious metal or a ceramic material.
